(19) United States
(12) Patent Application Publication
(10) Pub. No.: US 2012/0288267 A1
(43) Pub. Date: Nov. 15, 2012

(54) Mounting Bracket for a Camera

(75) Inventor: Mark Cuddeback, Green Bay, WI (US)

(73) Assignee: Non Typical, Inc., Green Bay, WI (US)

(21) Appl. No.: 13/104,161

(22) Filed: May 10, 2011

(51) Int. Cl. G03B 17/56

(52) U.S. Cl. 396/428

(57) ABSTRACT

A camera mounting bracket for supporting a camera in a position determined by a user comprising a quick connect/disconnect mounting assemblage that has a fastener-engaging channel for securing the mounting assemblage to a camera whereby the camera is able to be quickly connected/disconnected from the mounting assemblage.

### FIELD OF THE INVENTION

The invention relates to cameras and, more particularly, to the specific mounting of cameras.

### BACKGROUND OF THE INVENTION

There are many types of cameras, well-known in the art, which are used for a variety of purposes such as for recreation, security and media-related applications. Depending on the intended use of the camera, it can be advantageous to mount the camera using a variety of hardware options such as a tripod or bracket.

One specific and increasingly popular use for cameras is game animal observation for recreation and/or for scouting in association with hunting activities. Game animal observation or scouting activities can include implementation of scouting cameras for taking photographs, video footage, or other recordings. Use of scouting cameras for game animal observation or scouting is generally known.

Scouting cameras for scouting potential hunting areas and determining game patterns, particularly without disturbing animal activity, are generally well known in the art. Typically, the apparatus includes a film, digital or video camera and a passive infrared sensor (e.g., a motion/heat sensor) that is adapted to sense movement and, in response, activate the camera focused on the area in which the sensor detects movement. Oftentimes, these devices include a delay timer with multiple settings to match specific conditions or locations, thus eliminating unwanted multiple exposures or other non-desired events.

Known scouting cameras are typically set up using some type of mounting bracket. Many such scouting cameras utilize mounting brackets which are cumbersome and complex to set up. It would be advantageous to have a mounting bracket which has a quick connect/disconnect. Once a scouting camera is mounted onto a tree or other flat support surface, a user generally leaves the camera location and returns, frequently or infrequently, to view the images the camera has captured, making the camera a target for theft. Therefore, it would be advantageous to have a mounting bracket which could also act as a theft deterrent.

### OBJECTS OF THE INVENTION

It is an object of the present invention to provide a mounting bracket for a camera and in particular, a scouting camera which addresses these shortcomings by overcoming the aforesaid problems of the prior art. It is also an object of the present invention to provide a mounting bracket for a camera which has a quick connect/disconnect feature. It is a further object of the present invention to provide a mounting bracket for a camera which is easy to use, even in the field. Another object of the present invention is to provide a mounting bracket for a camera which incorporates a security feature to assist in preventing the camera from being stolen.

### SUMMARY OF THE INVENTION

The present invention is a camera mounting bracket for supporting a camera in a position determined by a user comprising a quick connect/disconnect mounting assemblage which includes a fastener-engaging channel for securing the mounting assemblage to a camera whereby the camera is able to be connected/disconnected quickly from the mounting assemblage.

In some preferred embodiments of the innovative mounting bracket, the mounting assemblage has two portions, a bracket member and an anchor member. In such embodiments, a fastener-engaging channel is formed on the bracket member and the camera includes fasteners for engagement with the channel. It is highly preferred that the bracket member and anchor member are pivotally attached.

In some preferred embodiments, the anchor member includes apertures to affix the mounting assemblage to a tree, building or other support surface. Preferably, the support surface can be a tree, building, stake, pole or the like. It is also preferred that the support surface such as a stake or pole be secured in the ground.

In other preferred embodiments, the anchor member includes two rotatably fixed axes, the axes being perpendicular to each other, whereby the camera has both pan and tilt adjustability. Preferably, the fastener-engaging channel is formed on the bracket member and the camera includes fasteners for engagement with the channel.

In some preferred embodiments, the mounting assemblage is a unitary, molded plastic piece. In other preferred embodiments, the mounting assemblage includes two slots for securing the bracket to a support surface.

It is highly preferred that the camera includes a lock mechanism for securing the camera to the mounting assemblage. The lock mechanism includes a shackle plate with a hole. The bracket member includes a lock plate with a corresponding hole. Both the shackle plate and lock plate accept a shackle of a padlock therethrough. Preferably, lock mechanism further includes a protective flange positioned to prevent access to the shackle of a padlock with a cutting tool.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 is a perspective view of a first embodiment of a camera mounting bracket attached to a tree with camera shown.

FIG. 2 is a side view of the mounting bracket of FIG. 1 attached to a camera with anchor member removed.

FIG. 3 is a rear elevational view of the mounting bracket of FIG. 1 attached to a camera with anchor member removed.

FIG. 4 is a perspective view of the mounting bracket of FIG. 1.

FIG. 5 is another perspective view of the mounting bracket of FIG. 1.

FIG. 6 is a front view of the mounting bracket of FIG. 1.

FIG. 7 is a bottom view of the mounting bracket of FIG. 1.

FIG. 8 is a front perspective view of a second embodiment of a mounting bracket.

FIG. 9 is a back perspective view of the mounting bracket of FIG. 8.

FIG. 10 is a side view of the mounting bracket of FIG. 8.

FIG. 11 is a front view of the mounting bracket of FIG. 8.

FIG. 12 is a back view of the mounting bracket of FIG. 8.

FIG. 13 is a perspective view of a third embodiment of a mounting bracket affixed to a support structure.

FIG. 14 is an exploded view of the mounting bracket of FIG. 13.

FIG. 15 is a side view of the mounting bracket of FIG. 13.

FIG. 16 is a perspective view of a fourth embodiment of a mounting bracket.

FIG. 17 is a side view of the mounting bracket of FIG. 1 illustrating the lock mechanism with a padlock.

FIG. 18 is a rear elevational view of the mounting bracket of FIG. 1 illustrating the lock mechanism with a padlock.

FIG. 19 is a rear elevational view of the mounting bracket of FIG. 1.

FIG. 20 is a rear elevational view of the mounting bracket of FIG. 1 illustrating interaction of lock mechanism and camera.

FIG. 21 is a perspective view of the lock mechanism.

FIG. 22 is a back view of the mounting bracket of FIG. 1 illustrating the lock mechanism.

FIG. 23 is a perspective view of the first embodiment of the camera mounting bracket illustrating interaction with a mounting surface.

### DETAILED DESCRIPTION OF PREFERRED EMBODIMENTS

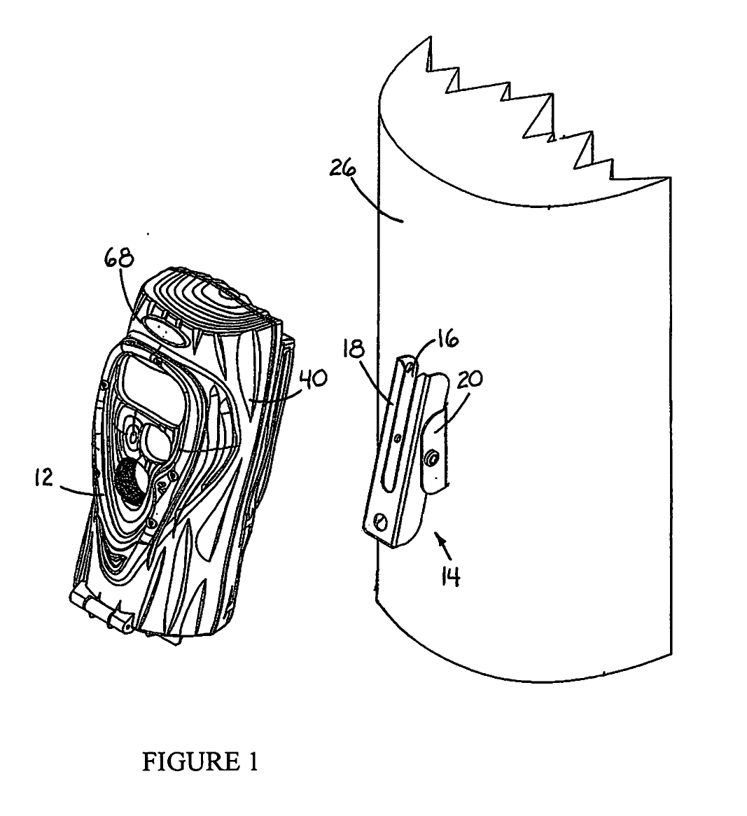

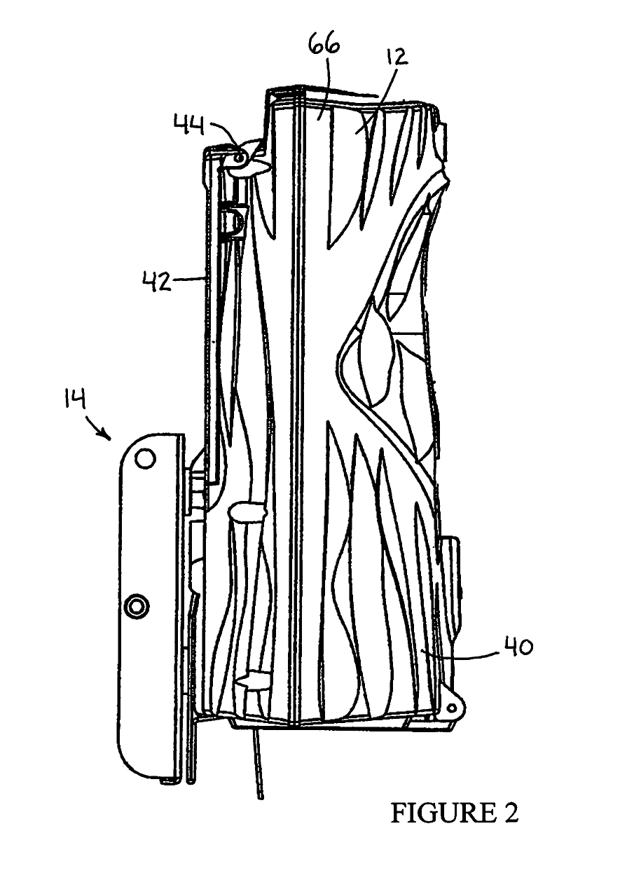

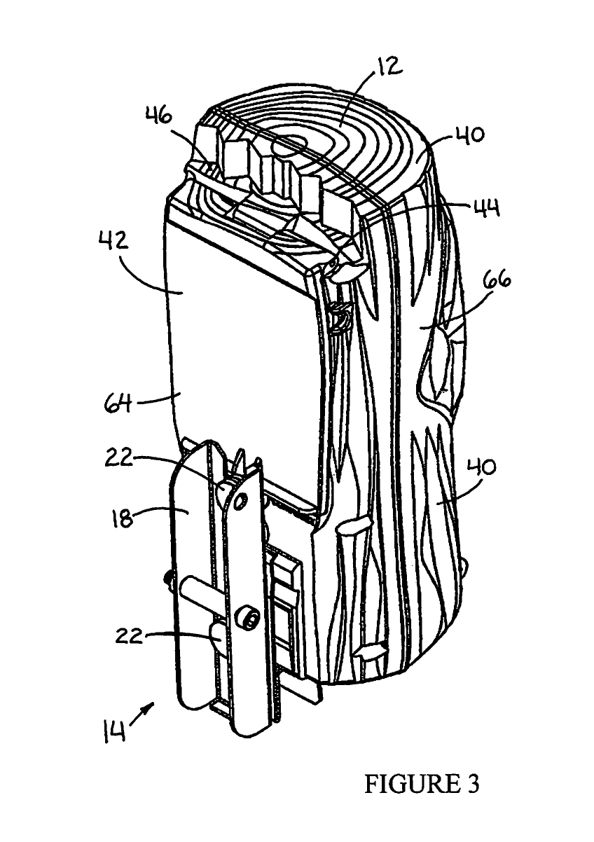

With initial reference to FIGS. 1-3, a mounting bracket 10 for a camera 12 is shown. Mounting bracket 10 supports camera 12 in a position determined by a user comprising a quick connect/disconnect mounting assemblage 14 which includes a fastener-engaging channel 16 for securing mounting assemblage 14 to camera 12 whereby camera 12 is able to be quickly connected/disconnected from mounting assemblage 14. It should be noted that FIGS. 1-3 illustrate camera 12 which is a scouting camera. However, mounting bracket 10 can be used on a variety of types of cameras (such as for recreation, security or media-related purposes) and is not limited to scouting cameras.

FIGS. 1-3 illustrate that camera 12 includes a main body 40 and a cover 42 that are joined together with a hinge 44 at a top portion of main body 40. At a bottom portion of the main body 40, fasteners 22 are located which also act as a lock. Fasteners 22 are preferably at least one thumbscrew 22 for temporarily holding and securing cover 42 against main body 40.

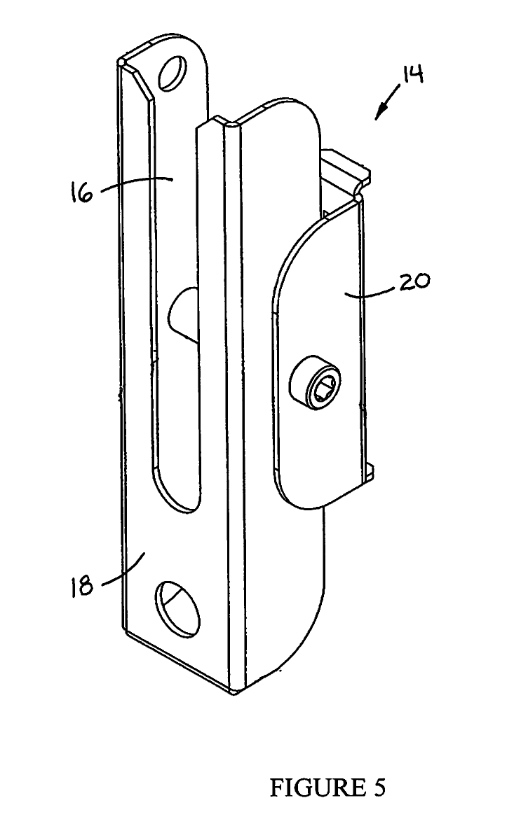

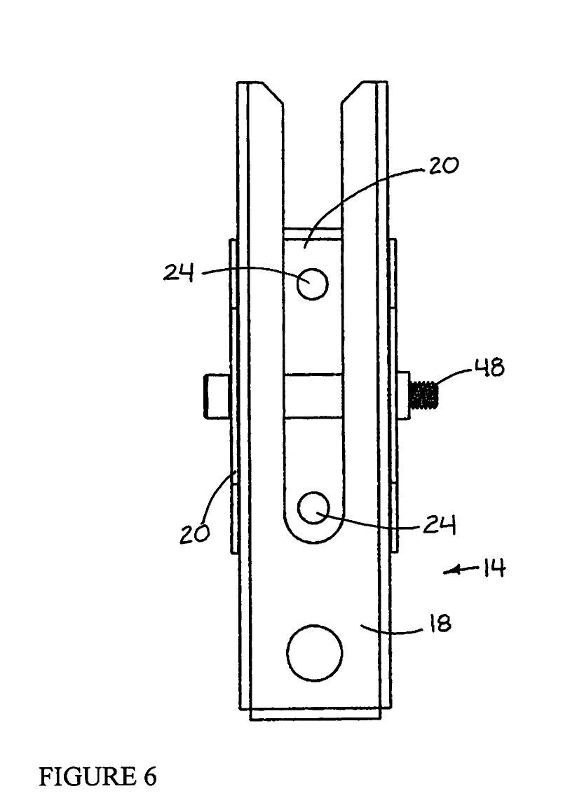

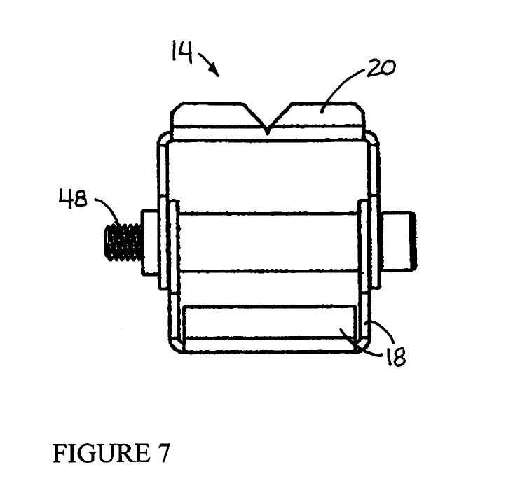

A first embodiment of mounting assemblage 14 is shown in FIGS. 1-7. Mounting assemblage 14 has two portions, a bracket member 18 and an anchor member 20. A fastener-engaging channel 16 is formed on bracket member 18, and camera 12 includes fasteners 22 for slidable engagement with channel 16.

Fastener-engaging channel 16 in some embodiments, is a key-hole shape (not shown) instead of a channel 16 as shown in the FIGURES. Fastener-engaging channel 16, when in the key-hole shape configuration, allows the head of the screw to fit into the round portion (at the top of the hole) and then allows the screw to slide down and lock into place. In this configuration, two or more key-holes are preferable to secure camera 12. Fastener-engaging channel 16 can be modified further to include a key-hole shape and a slot (not shown). Other similar configurations different from a straight channel 16 as shown in the FIGURES may be used.

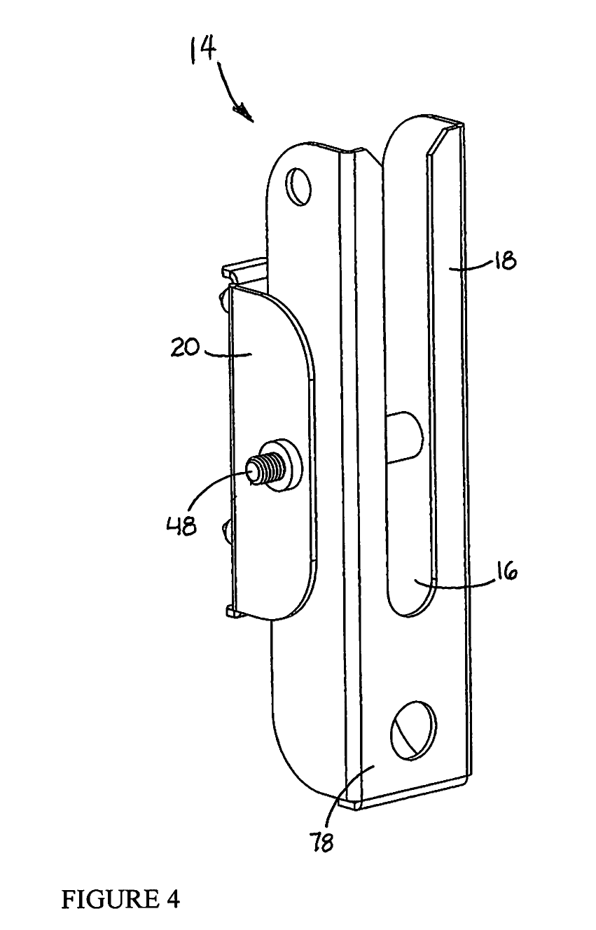

As illustrated best in FIGS. 4-6, bracket member 18 and anchor member 20 are pivotally attached by a screw 48 or the like. Anchor member 20 includes apertures 24 (one or many apertures 24 can be part of anchor member 20) to affix mounting assemblage 14 to a tree 26, building or other support surface. Mounting assemblage 14 can be affixed to any support surface on which it would be preferable to mount a camera.

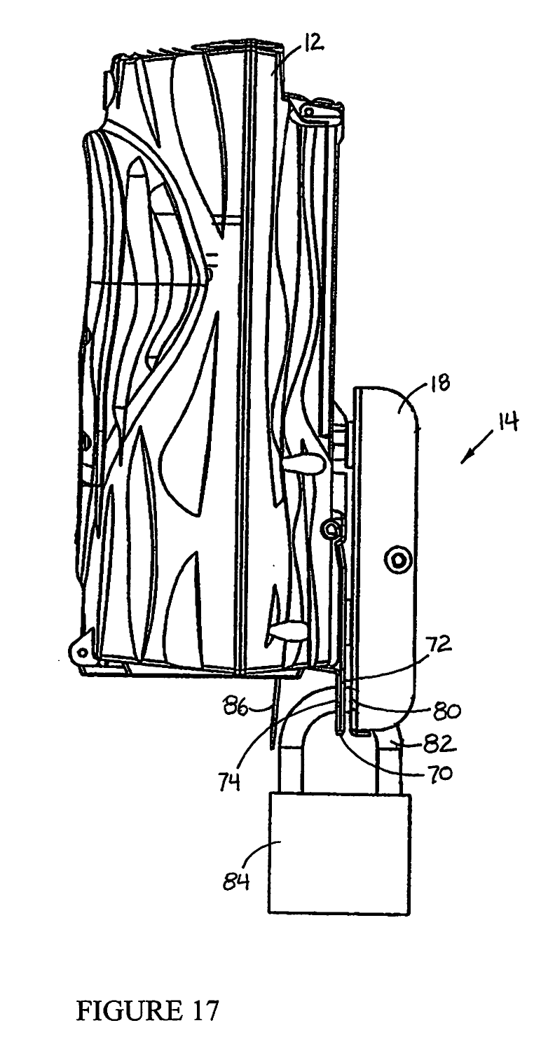

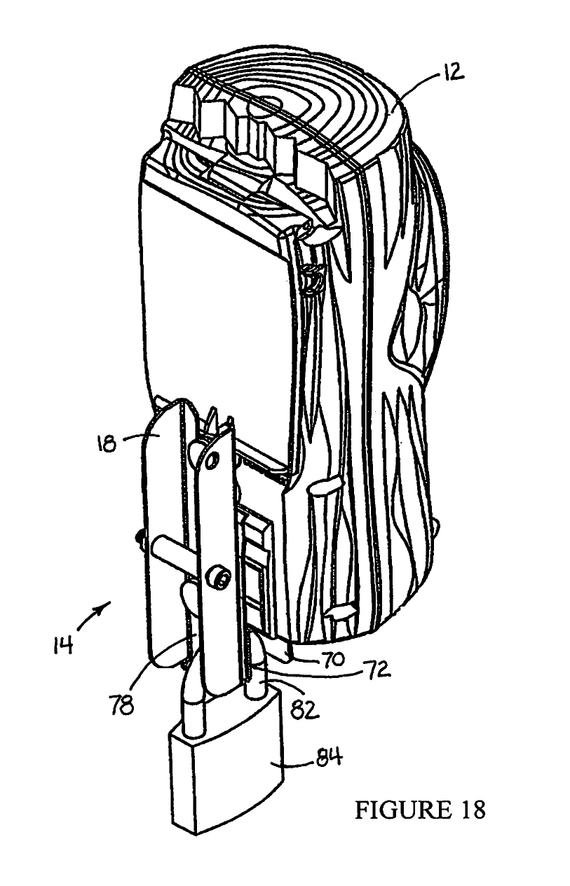

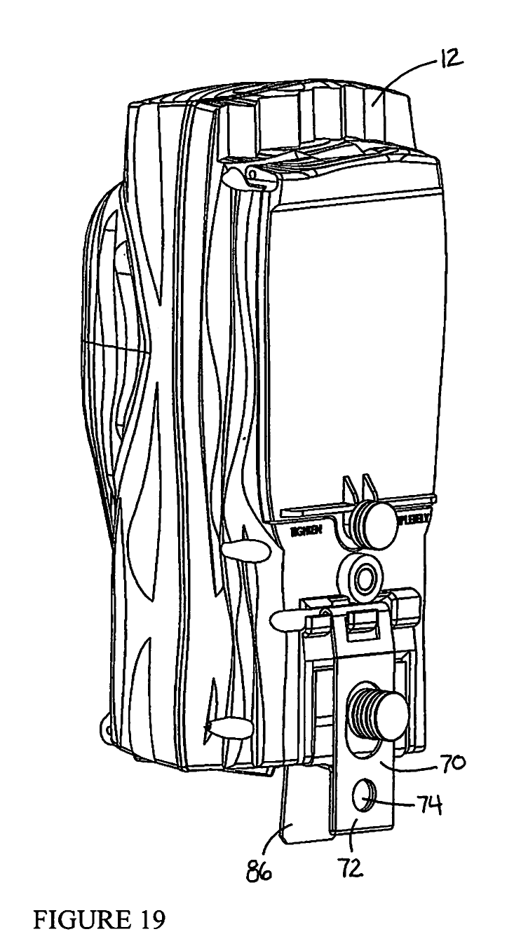

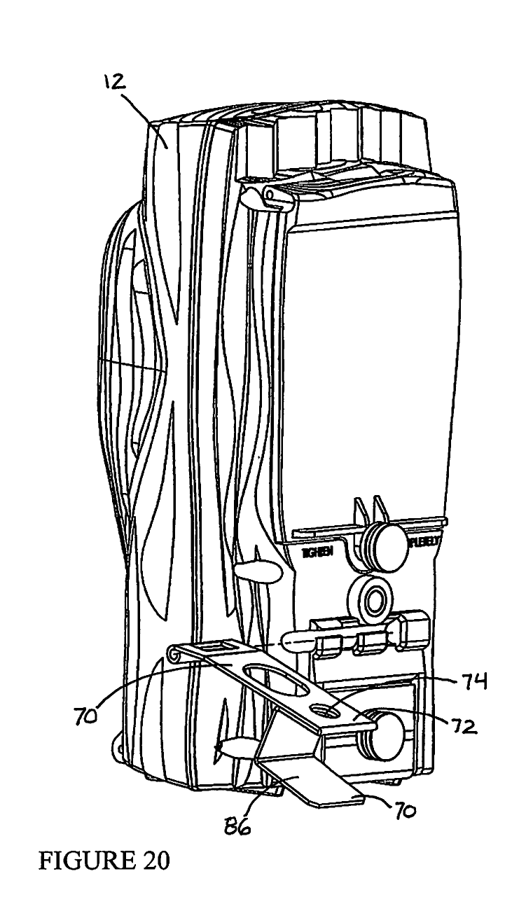

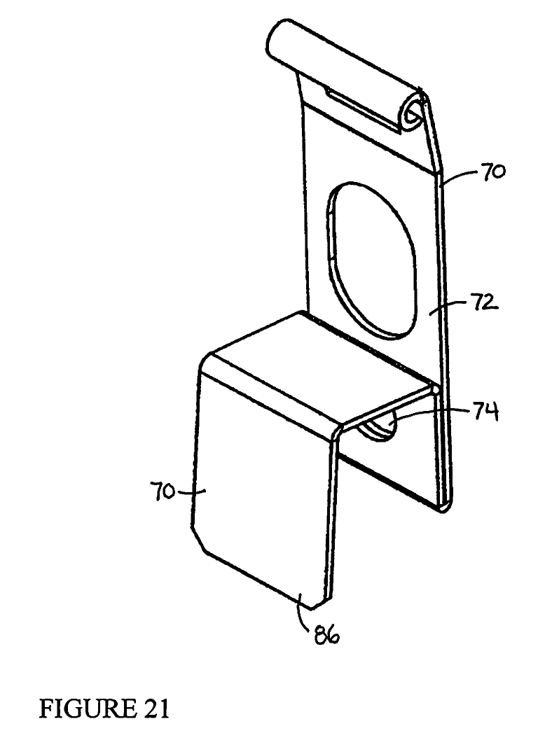

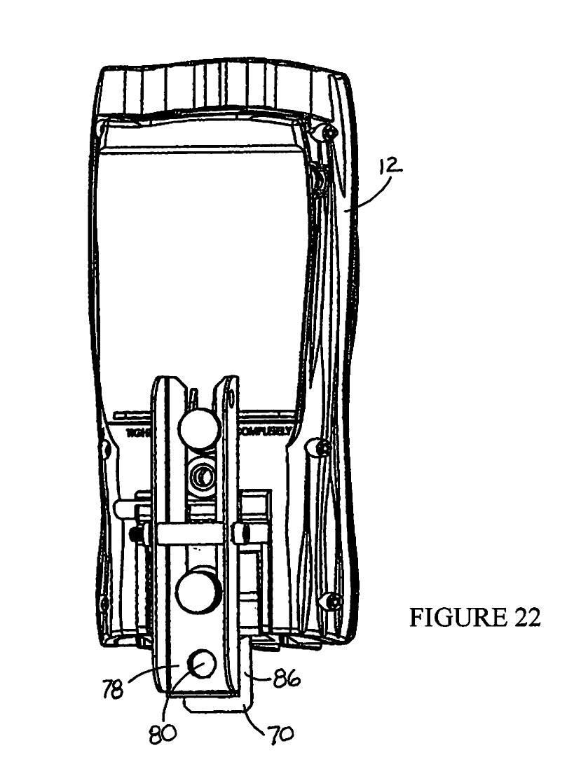

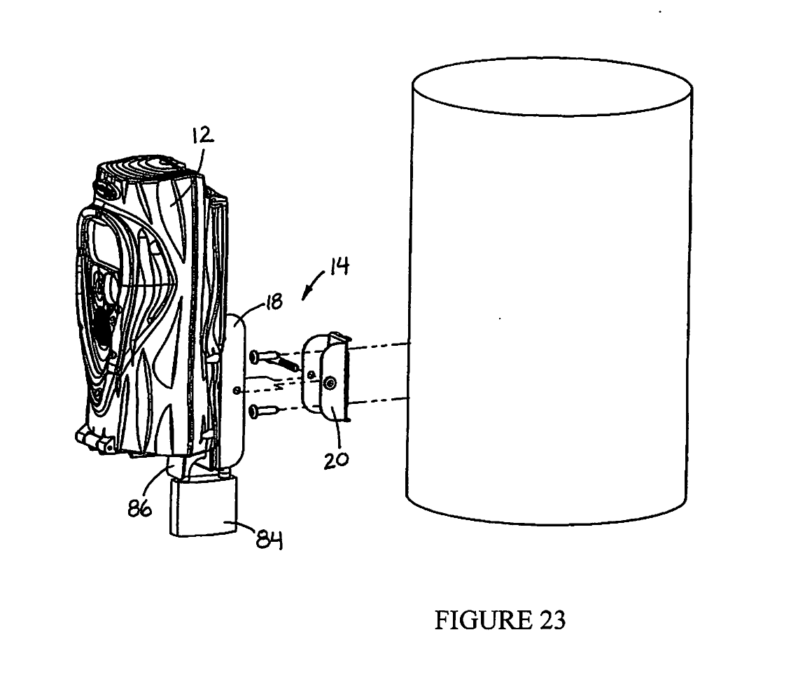

FIGS. 17-22 illustrate that camera 12 includes a lock mechanism 70 for securing camera 12 to mounting assemblage 14, lock mechanism 70 includes a shackle plate 72 with a hole 74. Bracket member 76 includes a lock plate 78 with a corresponding hole 80. Both shackle plate 72 and lock plate 78 accept a shackle 82 of a padlock 84 therethrough. FIGS. 17 and 19-21 illustrates that lock mechanism 70 further includes a protective flange 86 positioned to prevent access to the shackle 82 of a padlock 84 with a cutting tool, such as a bolt cutter (not shown). Configuration of protective flange 86 substantially reduces access to shackle 82 of padlock 84 thereby making cutting or tampering of shackle 82 more difficult as seen in FIG. 23.

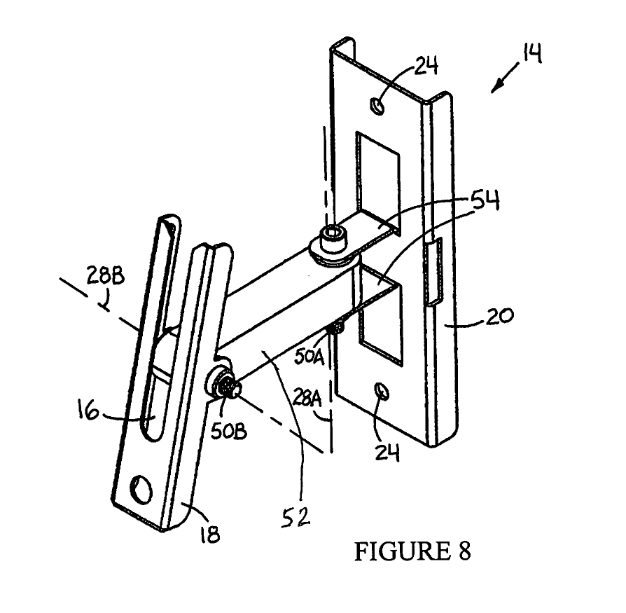

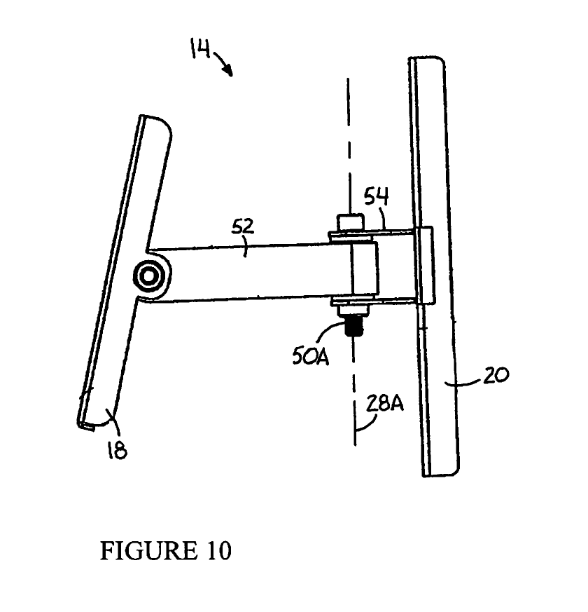

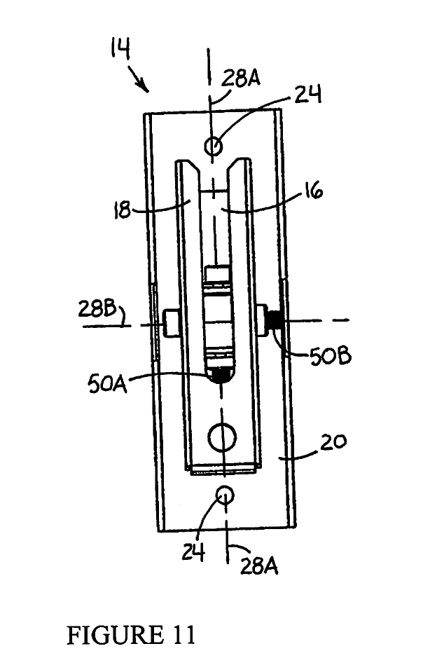

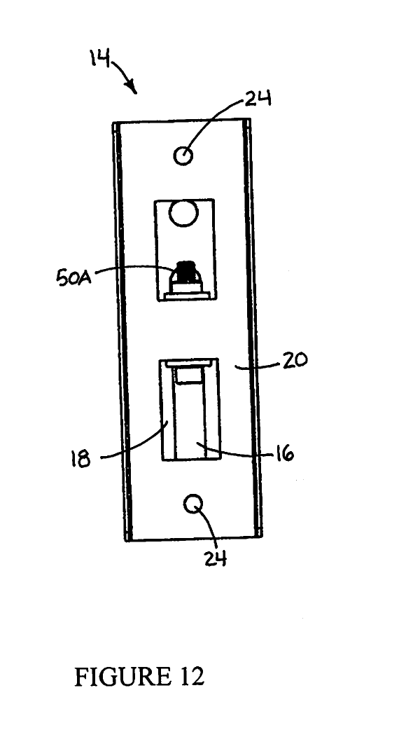

FIGS. 8-12 illustrate a second embodiment of mounting assemblage 14. Second embodiment, like the first embodiment, includes mounting assemblage 14 with two portions, a bracket member 18 and an anchor member 20. A fastener-engaging channel 16 is formed on bracket member 18, and camera 12 includes fasteners 22 for slidable engagement with channel 16. In the second embodiment, anchor member 20 includes two rotatably fixed axes 28, the axes 28 are perpendicular to each other. This axes orientation gives camera 12 both pan and tilt adjustability.

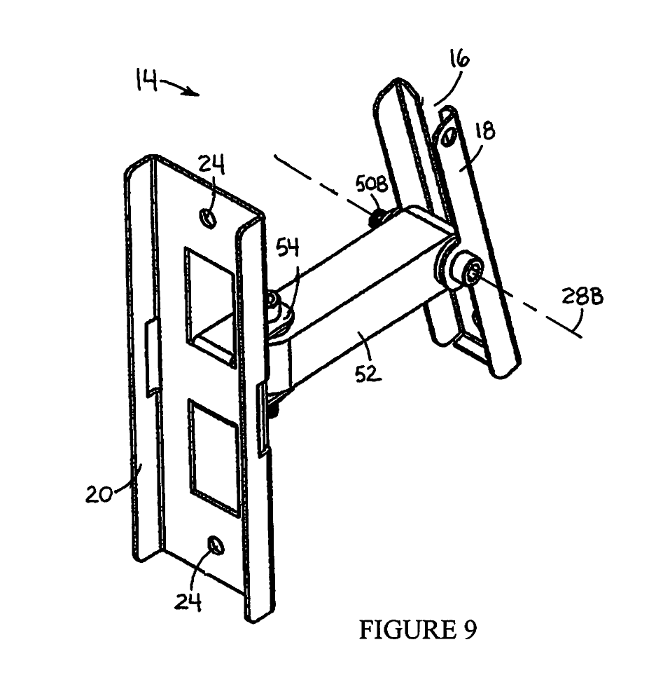

As shown in FIGS. 8-12, a screw 50 connects bracket member 18 to a first axis 52. A second screw 50 connects first axis to a second axis 54 as shown best in FIG. 8. Second axis 54 is connected to anchor member 20. Screw 50 enables first and second axes 52, 54 to have both pan and tilt ability. Therefore, when camera 12 is secured to bracket member 18, camera 12 can be oriented by a user in numerous directions given the pan and tilt ability of mounting assemblage 14. FIGS. 8 and 9 illustrate that anchor member 20 includes apertures 18 for mounting assemblage 14 to a support structure through the use of a screw or the like.

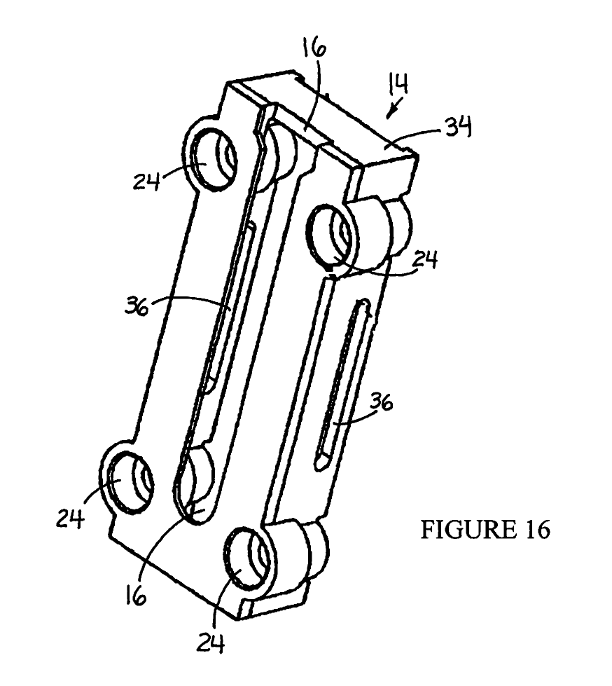

In a third embodiment, mounting assemblage 14 is a unitary, molded-plastic piece 34 as illustrated in FIG. 16. In this embodiment, mounting assemblage 14 is preferably injection molded. In this embodiment, it is preferable that mounting assemblage 14 includes two slots 36 for engagement with a strap (not shown) for securing mounting bracket 10 to a support surface. Mounting assemblage 14 in this embodiment also includes apertures 24 for securing mounting bracket 10 to a support surface such as a tree.

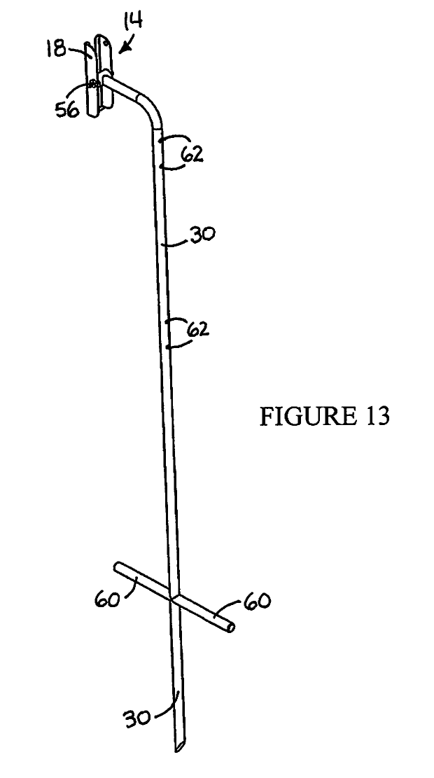

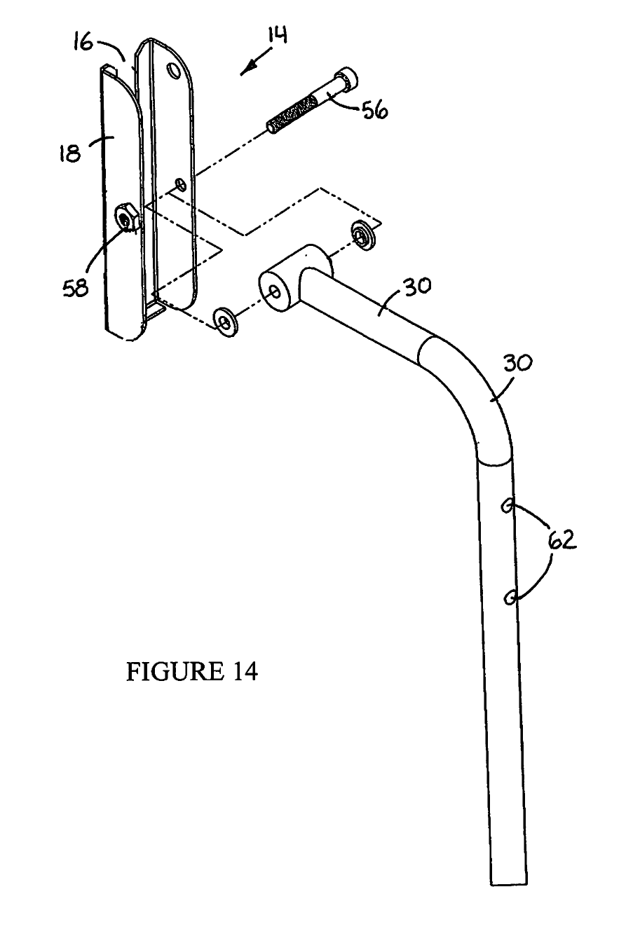

FIGS. 13-15 illustrate a fourth embodiment of mounting assemblage 14. In this embodiment, mounting assemblage 14 consists of bracket member 18 as a unitary structure. Bracket member 18 is secured to a stake or pole 30 (which acts as a support surface) through the use of a threaded screw 56 with nut 58 (or similar securement structure). This allows bracket member 18 to pivot with respect to the stake or pole 30.

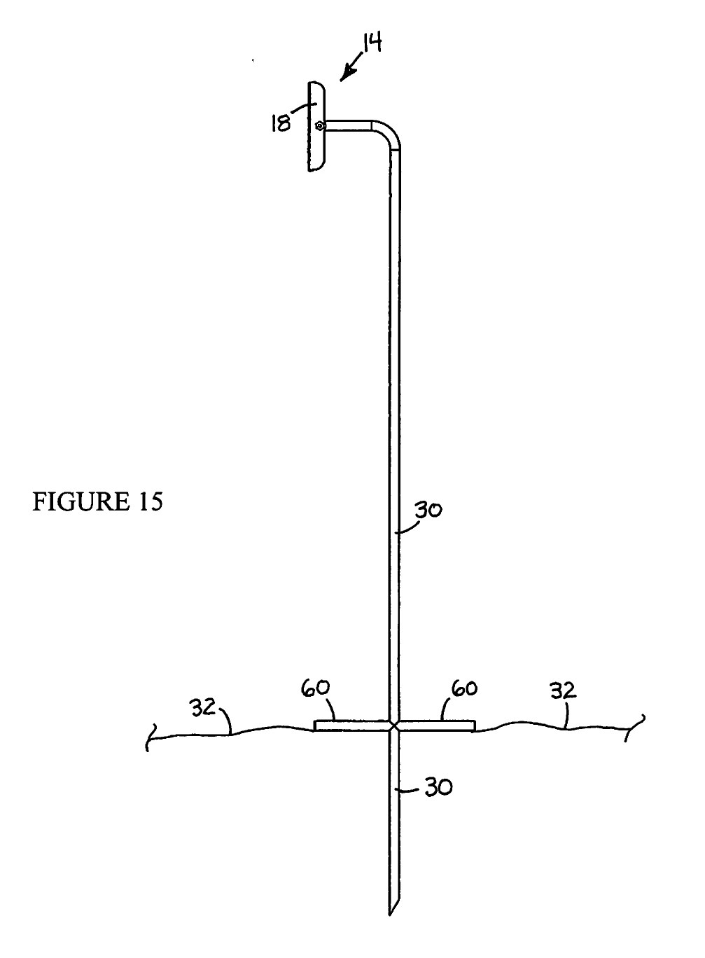

As noted, the support surface can be a stake or pole 30 as shown in FIGS. 13-15. It is preferable if the support surface is a stake or pole 30 that stake or pole 30 be secured in the ground 32 as seen in FIG. 15. It is preferable, though not necessary, that stake or pole 30 include a step bar 60 for easy insertion of stake or pole 30 into ground 32. Stake or pole 30 may also include holes 62 so that stake or pole 30 can be directly mounted to a support surface such as a tree.

The first, second and fourth embodiments of this application describe a mounting assemblage 14 which is preferably made of powder-coated metal. Stake or pole 30 in the fourth embodiment is also preferably made of metal; however, an acceptable alternative such as wood may also be used.

Mounting bracket 10 can work in conjunction with numerous types of cameras 12. As shown in FIGS. 1-3, main body 10 of camera 12 is typically a box-like enclosure that has a back wall 64, multiple sidewalls 66 extending therefrom, and a front wall 68. Front wall 68 generally holds an infrared illuminator, a camera window, and a sensor, such as a heat-in-motion sensor (see generally FIG. 1).

While the principles of this invention have been described in connection with specific embodiments, it should be understood clearly that these descriptions are made only by way of example and are not intended to limit the scope of the invention.

1. A camera mounting bracket for supporting a camera in a position determined by a user comprising a quick connect/disconnect mounting assemblage having an open-ended fastener-engaging channel for slidably securing a camera thereto, whereby the camera is able to be quickly connected/disconnected from the mounting assemblage.

2. The mounting bracket of claim 1 wherein the mounting assemblage has two portions, including a bracket member and an anchor member.

3. The mounting bracket of claim 2 wherein the fastener-engaging channel is formed on the bracket member and the camera includes fasteners for engagement with the channel.

4. The mounting bracket of claim 2 wherein the bracket member and anchor member are pivotally attached to one another.

5. The mounting bracket of claim 2 wherein the anchor member includes apertures to affix the mounting assemblage to a tree, building or other support surface.

6. The mounting bracket of claim 2 wherein the anchor member includes a pivot arm defining two fixed rotation axes, the axes being substantially perpendicular to each other, whereby the camera has both pan and tilt adjustability.

7. The mounting bracket of claim 6 wherein the fastener-engaging channel is formed on the bracket member and the camera includes fasteners for engagement with the channel.

8. The mounting bracket of claim 6 wherein the anchor member includes apertures to affix the mounting assemblage to a support surface.

9. The mounting bracket of claim 8 wherein the support surface is a tree.

10. The mounting bracket of claim 1 wherein the mounting bracket is affixed to a stake or pole and the camera includes fasteners for engagement with the fastener-engaging channel.

11. The mounting bracket of claim 10 wherein the stake or pole is securable to the ground.

12. The mounting bracket of claim 1 wherein the mounting assemblage is a unitary, molded plastic piece.

13. The mounting bracket of claim 12 wherein the camera includes fasteners for engagement with the fastener-engaging channel.

14. The mounting bracket of claim 12 wherein the mounting assemblage includes two slots for securing the bracket to a support surface using a strap extending through the slots.

15. The mounting bracket of claim 14 wherein the support surface is a tree.

16. The mounting bracket of claim 1 wherein the camera includes a lock mechanism for securing the camera to the mounting assemblage, the lock mechanism including a shackle plate with a hole, the bracket member including a lock plate portion with a corresponding aligned hole, both the shackle plate and lock plate portion accepting a shackle of a padlock therethrough.

17. The mounting bracket of claim 16 wherein the lock mechanism further includes a protective flange positioned to prevent access to the shackle of a padlock with a cutting tool.
